(19) United States
(12) Patent Application Publication
(10) Pub. No.: US 2020/0249521 A1
(43) Pub. Date: Aug. 6, 2020

(54) DISPLAY SUBSTRATE AND DISPLAY DEVICE

(71) Applicants: BOE Technology Group Co., Ltd., Beijing (CN); Beijing BOE Optoelectronics Technology Co., Ltd., Beijing (CN)

(72) Inventors: Yongshan ZHOU, Beijing (CN); Jian LI, Beijing (CN); Tingze DONG, Beijing (CN)

(21) Appl. No.: 15/768,130

(22) PCT Filed: Oct. 19, 2017
(86) PCT No.: PCT/CN2017/106841

§ 371 Date: Apr. 13, 2018

(30) Foreign Application Priority Data
Feb. 22, 2017 (CN) 201710096300.8

(51) Int. Cl. G02F 1/1335; G02F 1/1339

(52) U.S. Cl. CPC G02F 1/133512; G02F 1/133514; G02F 1/1339

(57) ABSTRACT

A display substrate and a display device are provided. The display substrate comprises: a substrate and a black matrix layer disposed on the substrate, wherein the black matrix layer includes a first black matrix located in a middle region of the display substrate. The display substrate further includes a sealing member, which is at least in close abutment with the edge of the first black matrix. The sealing member is in close abutment with the substrate and is in close abutment with the edge of the first black matrix at the same time, that is, the edge of the first black matrix is sealed by the sealing member. Therefore, even if peeling occurs at the edge of the first black matrix, water vapor molecules are blocked by the sealing member and cannot enter into the middle region of the display substrate.

### CROSS-REFERENCE TO RELATED APPLICATIONS

This is a National Phase Application filed under 35 U.S.C. 371 as a national stage of PCT/CN2017/106841, filed on Oct. 19, 2017, an application claiming the benefit of Chinese Application No. 201710096300.8, filed on Feb. 22, 2017, the content of each of which is hereby incorporated by reference in its entirety.

### FIELD OF THE INVENTION

The present disclosure relates to a field of display technology, and especially, to a display substrate and a display device.

### BACKGROUND OF THE INVENTION

After the development of thin-film transistor display (TFT-LCD) technology in recent decades, the technology and process thereof have been maturing. This kind of display has replaced the cold cathode diode (CCFL) display, and becomes the leading product in the display field.

At present, the specific steps for forming a liquid crystal cell are as follows: at first, a sealant is coated around a glass substrate, and then a liquid crystal is dropped at the center of another glass substrate using a drip method. After the two glass substrates are laminated by the vacuum lamination, the sealant is finally cured to complete a cell process. In the production process of a LCD panel, in order for liquid crystal molecules to be normally oriented, a layer of polyimide (PI) film needs to be coated on the surface of the array substrate and the color filter substrate, and then a rubbing process is performed on the PI film to realize the orientation of the liquid crystal molecules. Therefore, the PI film coating (Coater) of the array substrate and the color filter substrate is a very important process. The key point of the PI film coating is the APR transfer printing, and the design and fixation of the APR plate has a great influence on the transfer effects of the oriented film.

Nowadays, there is such problem for a variety of products that, when exposed to a pressurization test environment with high temperature and high humidity, the black matrix (BM) on the color filter substrate deforms and is peeled off (which may be caused by insufficient adhesive force). After the peeling of BM, water vapor molecules will infiltrate through cracks and then enter into the display area to form large bubbles, which seriously affect the yield of the product.

### SUMMARY OF THE INVENTION

The present disclosure aims to solve at least one of the technical problems existing in the art, and provides a display substrate and a display device, wherein the peeling of BM, which causes water vapor to enter into the display area, can be effectively prevented.

According to an embodiment of the present disclosure, it is provided a display substrate, comprising: a substrate and a black matrix layer disposed on the substrate, wherein the black matrix layer includes a first black matrix located in a middle region of the display substrate.

The display substrate further includes a sealing member, which is in close abutment with the substrate and is in close abutment with the edge of the first black matrix at the same time. Thus, the edge of the first black matrix is blocked and sealed by the sealing member. Even if peeling occurs at the edge of the first black matrix, water vapor molecules are blocked by the sealing member and cannot enter into the middle region of the display substrate, that is to say, the water vapor cannot enter into the display region of the display substrate, so that the problem of lower product yield due to peeling of the black matrix in the prior art can be solved.

Optionally, the display substrate further includes a protective layer on the side of the black matrix layer facing away from the substrate.

Optionally, a sealant is further provided in the peripheral region of the liquid crystal located above the display substrate.

Optionally, the first black matrix protrudes from the protective layer; the sealing member envelops the outer surface of a protruding portion of the first black matrix, and the sealing member is in close abutment with the edge of the protective layer. Accordingly, the outer surface of the protruding portion of the first black matrix is enveloped by the sealing member, that is, the edge of the first black matrix is blocked by the sealing member. In this state, even if peeling occurs at the edge of the first black matrix, water vapor molecules are blocked by the sealing member and cannot enter into the middle region of the display substrate (that is, the water vapor cannot enter into the display region of the display substrate), so that the problem of lower product yield due to peeling of the black matrix in the prior art can be solved.

Optionally, the sealing member and the sealant are integrally formed. Accordingly, the preparation process of the display substrate can be simplified; the preparation cost can be reduced; and the adhesive force between the sealant and the substrate can be enhanced, so that the sealability of the sealing member to the edge of the first black matrix can be further improved.

Optionally, the protective layer and the sealing member are integrally formed. Accordingly, the display substrate can be easily prepared and completed. Moreover, the adhesive force between the protective layer and the substrate can be enhanced, so that the sealability of the sealing member to the edge of the first black matrix can be further improved.

Optionally, the black matrix layer further includes a second black matrix located in a peripheral region of the display substrate; the sealing member is filled between the first black matrix and the second black matrix. Accordingly, the light leakage in the peripheral region of the display substrate can be effectively prevented.

Optionally, the display substrate is a color filter substrate.

Optionally, the display substrate is a COA substrate.

According to an embodiment of the present disclosure, it is provided a display device including the above-mentioned display substrate.

### BRIEF DESCRIPTION OF THE DRAWINGS

FIG. 1 is a schematic view of a display substrate according to an embodiment of the present disclosure;

FIG. 2 is a schematic view of a display substrate according to an embodiment of the present disclosure;

FIG. 3 is a schematic view of a display substrate according to an embodiment of the present disclosure;

FIG. 4 is a schematic view of a display substrate according to an embodiment of the present disclosure;

FIG. 5 is a schematic view of a display substrate according to an embodiment of the present disclosure;

### SUMMARY OF THE INVENTION

In order to make a person skilled in the art better understand the technical solution of the present disclosure, the present disclosure will be further described in detail in conjunction with the accompanying drawings and specific embodiments.

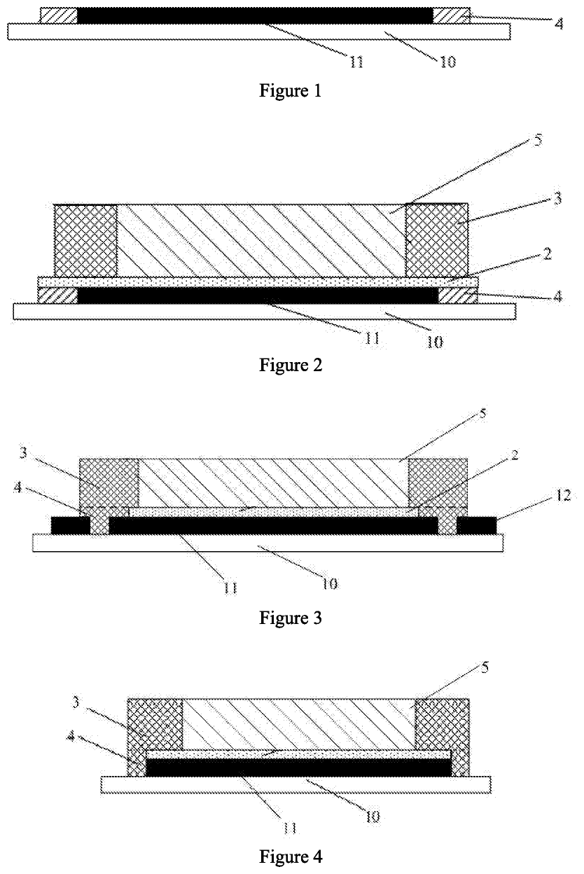

As shown in FIG. 1, the present embodiment provides a display substrate comprising a substrate 10 and a black matrix layer disposed on the substrate 10. The black matrix layer includes a first black matrix 11 located in a middle region of the display substrate. The display substrate further includes a sealing member 4, which is in close abutment with the substrate 10 and is in close abutment with the edge of the first black matrix 11 at the same time.

It should be noted that, the middle region in a display substrate includes a display region for displaying in the display substrate; that is, the area of the middle region is larger than that of the display region.

Optionally, the black matrix layer further includes a second black matrix 12 (not shown in FIG. 1) located in a peripheral region of the display substrate; the sealing member 4 is filled between the first black matrix 11 and the second black matrix 12. Accordingly, the light leakage in the peripheral region of the display substrate can be effectively prevented.

Since the edge of the first black matrix 11 according to the display substrate of the present embodiment is blocked and sealed by the sealing member 4, even if peeling occurs at the edge of the first black matrix 11, water vapor molecules are blocked by the sealing member 4 and cannot enter into the middle region of the display substrate (that is, the water vapor cannot enter into the display region of the display substrate), so that the problem of lower product yield due to peeling of the black matrix in the prior art can be solved.

As shown in FIG. 2, the present embodiment provides a display substrate, which further includes a protective layer 2 disposed on a black matrix layer on the basis of the display substrate shown in the above Embodiment. Moreover, a sealant 3 is further disposed in the peripheral region of liquid crystal 5 located above the display substrate.

Optionally, the black matrix layer further includes a second black matrix 12 (not shown in FIG. 2) located in a peripheral region of the display substrate; the sealing member 4 is filled between the first black matrix 11 and the second black matrix 12. In this case, the light leakage in the peripheral region of the display substrate can be effectively prevented.

Since the edge of the first black matrix 11 according to the display substrate of the present embodiment is blocked and sealed by the sealing member 4, even if peeling occurs at the edge of the first black matrix 11, water vapor molecules are blocked by the sealing member 4 and cannot enter into the middle region of the display substrate (that is, the water vapor cannot enter into display region of the display substrate), so that the problem of lower product yield due to peeling of the black matrix in the prior art can be solved.

The present embodiment provides a display substrate comprising a substrate 10, a black matrix layer disposed on the substrate 10, and a protective layer 2 disposed on the black matrix layer. Moreover, a sealant 3 is further disposed in the peripheral region of liquid crystal 5 located above the display substrate. The black matrix layer includes a first black matrix 11 located in a middle region of the display substrate, and the edge of the first black matrix 11 protrudes from the protective layer 2. As show in FIG. 3, steps are formed at the edges of the first black matrix 11 and the protective layer 2. In particular, the display substrate of the present embodiment further includes a sealing member 4 which envelops the outer surface of the protruding portion of the first black matrix 11, and the sealing member 4 is in close abutment with the edge of the protective layer 2. That is, the sealing member 4 is mated with the steps formed at the edges of the first black matrix 11 and the protective layer 2.

Since the sealing member 4 of the display substrate of the present embodiment envelops the outer surface of the protruding portion of the first black matrix 11, and the sealing member 4 is in close abutment with the edge of the protective layer 2, even if peeling occurs at the edge of the first black matrix 11, water vapor molecules are blocked by the sealing member 4 and cannot enter into the middle region of the display substrate (that is, the water vapor cannot enter into the display region of the display substrate), so that the problem of lower product yield due to peeling of the black matrix in the prior art can be solved. Meanwhile, an adhesive force between the sealing member 4 and the substrate 10 may be enhanced by the design of the steps at the edges of the first black matrix 11 and the protective layer 2.

Optionally, as shown in FIG. 3, the sealing member 4 and the sealant 3 may be integrally formed. That is, the sealing member 4 is formed while the sealant 3 is formed on the substrate 10 on which the protective layer 2 is provided. In this case, the sealing member 4 corresponds to a part of the sealant 3. Meanwhile, due to the design of the steps at the edges of the first black matrix 11 and the protective layer 2, the adhesive force between the sealant 3 and the substrate 10 may be enhanced.

Optionally, as shown in FIG. 3, the black matrix layer further includes a second black matrix 12 located in a peripheral region of the display substrate; the sealing member 4 is filled between the first black matrix 11 and the second black matrix 12. In this case, the light leakage in the peripheral region of the display substrate may be effectively prevented.

In the following, the method for preparing the above-mentioned display substrate will be described, and the structure of the display substrate will be further described.

Step 1: a black matrix material is provided on the substrate 10, and a groove is formed in a peripheral region of the black matrix material by a patterning process, so that a first black matrix 11 in the display region and a second black matrix 12 in the peripheral region are formed.

Step 2: a protective layer 2 material is provided on the substrate 10 as finished above, and then a protective layer 2 is formed by a patterning process. At the same time, the edge of the first black matrix 11 protrudes from the protective layer 2, so that steps are formed at the edges of the protective layer 2 and the first black matrix 11.

Step 3: a sealant 3 material is provided on the substrate 10 as finished above. At this time, the groove between the first black matrix 11 and the second black matrix 12 is filled with the sealant 3 material, so that the sealant 3 is formed while the sealing member 4 is also formed.

So far, the preparation of the display substrate is completed.

The first black matrix 11 and the second black matrix 12 according to the display substrate of the present embodiment are disconnected, so that the edge of the first black matrix 11 protrudes from the protective layer 2 to form a step. And then, the sealant 3 material is applied in a liquid state, so that the sealant 3 material fills the entire region. Because of the blocking of the sealant 3, even if peeling occurs at the second black matrix 12, water vapor molecules are blocked by the sealant 3 and cannot enter into the display substrate. In particular, when steps are formed at the edges of the first black matrix 11 and the protective layer 2, the adhesive force between the sealant and the display substrate can be effectively enhanced, and at the same time, the peeling of the black matrix due to the deformation of the substrate can be effectively prevented.

The present embodiment provides a display substrate comprising a substrate 10, a black matrix layer disposed on the substrate 10, and a protective layer 2 disposed on the black matrix layer. Moreover, a sealant 3 is further disposed in the peripheral region of liquid crystal 5 located above the display substrate. As shown in FIG. 4, the black matrix layer includes a first black matrix 11 located in a middle region of the display substrate, and the edge of the first black matrix 11 is flush with the edge of the protective layer 2. The display substrate in the present embodiment further includes a sealing member 4, which is in close abutment with the entire edge of the first black matrix 11 and the entire edge of the protective layer 2 respectively, and is also in close abutment with the substrate 10.

Optionally, the black matrix layer further includes a second black matrix 12 (not shown in FIG. 4) located in a peripheral region of the display substrate; the sealing member 4 is filled between the first black matrix 11 and the second black matrix 12. In this case, the light leakage in the peripheral region of the display substrate can be effectively prevented.

Since the sealing member 4 according to the display substrate of the present embodiment is in close abutment with the entire edge of the first black matrix 11 and the entire edge of the protective layer 2 respectively, and is also in close abutment with the substrate 10, even if peeling occurs at the edge of the first black matrix 11, water vapor molecules are blocked by the sealing member 4 and cannot enter into the middle region of the display substrate (that is, the water vapor cannot enter into display region of the display substrate), so that the problem of lower product yield due to peeling of the black matrix in the prior art can be solved.

Optionally, as shown in FIG. 4, the sealing member 4 and the sealant 3 may be integrally formed. That is, the sealing member 4 is formed while the sealant 3 is formed on the substrate 10 on which the protective layer 2 is provided. At this time, the sealing member 4 corresponds to a part of the sealant 3.

In the following, the method for preparing the above-mentioned display substrate will be described, and the structure of the display substrate will be further described.

Step 1: a black matrix material is provided on the substrate 10, and then a first black matrix 11 in the display region is formed by a patterning process.

Step 2: a protective layer 2 material is provided on the substrate 10 as completed above, and then a protective layer 2 is formed by a patterning process. At the same time, the edge of the first black matrix 11 is flush with the edge of the protective layer 2.

Step 3: a sealant 3 material is provided on the substrate 10 as completed above. At this time, the sealant 3 material envelops the edge of the first black matrix 11 and the edge of the protective layer 2, so that the sealant 3 is formed while the sealing member 4 is also formed.

So far, the preparation of the display substrate is completed.

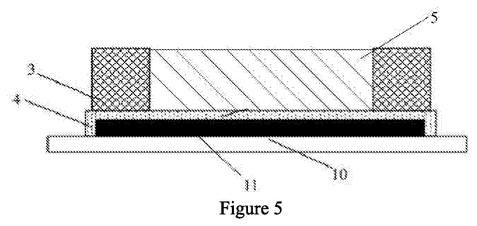

The present embodiment provides a display substrate, comprising: a substrate 10; a black matrix layer, which is disposed on the substrate 10 and includes a first black matrix 11 located in a middle region of the display substrate; and a protective layer 2, which is disposed on the black matrix layer. Moreover, a sealant 3 is further disposed in the peripheral region of liquid crystal 5 located above the display substrate. As shown in FIG. 5, the display substrate further includes a sealing member 4, which is in close abutment with the substrate 10 and is in close abutment with the first black matrix 11 at the same time. Moreover, the sealing member 4 and the protective layer 2 are integrally formed. That is, the protective layer 2 envelops the first black matrix 11.

Optionally, the black matrix layer further includes a second black matrix 12 (not shown in FIG. 5) located in a peripheral region of the display substrate; the sealing member 4 is filled between the first black matrix 11 and the second black matrix 12. In this case, the light leakage in the peripheral region of the display substrate may be effectively prevented.

In the display substrate of the present embodiment, since the sealing member 4 and the protective layer 2 are integrally formed, the display substrate can be easily prepared and completed. Meanwhile, the edge of the first black matrix 11 is blocked by the sealing member 4. Therefore, even if peeling occurs at the edge of the first black matrix 11, water vapor molecules are blocked by the sealing member 4 and cannot enter into the middle region of the display substrate (that is, the water vapor cannot enter into the display region of the display substrate), so that the problem of lower product yield due to peeling of the black matrix in the prior art can be solved.

The method for preparing the above-mentioned display substrate will be described below, and the structure of the display substrate will be further described.

Step 1: a black matrix material is provided on the substrate 10, and then a first black matrix 11 in the display region is formed by a patterning process.

Step 2: a protective layer 2 material is provided on the substrate 10 as completed above. Then the protective layer 2 and sealing member 4 are integrally formed by a patterning process. That is, the protective layer 2 material envelops the first black matrix 11.

Step 3: a sealant 3 material is formed on the substrate 10 as completed above .

So far, the preparation of the display substrate is completed.

The display substrate provided in the above embodiments may be a color filter substrate or a COA substrate (Color On Array).

The present embodiment provides a display device including any one of the display substrates described in the above Embodiments. Therefore, the display device of the present embodiment has a higher yield.

The display device may be a liquid crystal display device, such as a liquid crystal panel, an electronic paper, an OLED panel, a mobile phone, a tablet computer, a television, a monitor, a notebook computer, a digital photo frame, a navigator, or any product or component having a display function.

It may be understood that the aforementioned embodiments are merely exemplary embodiments used for illustrating the principle of the present disclosure, and the present disclosure is not limited thereto. For a person skilled in the art, various variations and improvements may be made without departing from the spirit and essence of the present disclosure, and those variations and improvements are also encompassed within the protection scope of the present disclosure.

1-11. (canceled)

12. A display substrate, comprising: a substrate and a black matrix layer disposed on the substrate, wherein the black matrix layer includes a first black matrix located in a middle region of the display substrate,
the display substrate further includes a sealing member, which is in close abutment with the substrate and is in close abutment with the edge of the first black matrix at the same time.

13. The display substrate according to claim 12, wherein the display substrate further includes a protective layer on the side of the black matrix layer facing away from the substrate.

14. The display substrate according to claim 13, wherein a sealant is further provided in the peripheral region of the liquid crystal located above the display substrate.

15. The display substrate according to claim 14, wherein the sealing member and the sealant are integrally formed.

16. The display substrate according to claim 14, wherein the first black matrix protrudes from the protective layer; the sealing member envelops the outer surface of the protruding portion of the first black matrix, and the sealing member is in close abutment with the edge of the protective layer.

17. The display substrate according to claim 16, wherein the sealing member and the sealant are integrally formed.

18. The display substrate according to claim 14, wherein the protective layer and the sealing member are integrally formed.

19. The display substrate according to claim 12, wherein the black matrix layer further includes a second black matrix located in a peripheral region of the display substrate; the sealing member is filled between the first black matrix and the second black matrix.

20. The display substrate according to claim 13, wherein the black matrix layer further includes a second black matrix located in a peripheral region of the display substrate; the sealing member is filled between the first black matrix and the second black matrix.

21. The display substrate according to claim 14, wherein the black matrix layer further includes a second black matrix located in a peripheral region of the display substrate; the sealing member is filled between the first black matrix and the second black matrix.

22. The display substrate according to claim 15, wherein the black matrix layer further includes a second black matrix located in a peripheral region of the display substrate; the sealing member is filled between the first black matrix and the second black matrix.

23. The display substrate according to claim 16, wherein the black matrix layer further includes a second black matrix located in a peripheral region of the display substrate; the sealing member is filled between the first black matrix and the second black matrix.

24. The display substrate according to claim 17, wherein the black matrix layer further includes a second black matrix located in a peripheral region of the display substrate; the sealing member is filled between the first black matrix and the second black matrix.

25. The display substrate according to claim 18, wherein the black matrix layer further includes a second black matrix located in a peripheral region of the display substrate; the sealing member is filled between the first black matrix and the second black matrix.

26. The display substrate according to claim 12, wherein the display substrate is a color filter substrate.

27. The display substrate according to claim 12, wherein the display substrate is a COA substrate.

28. A display device, comprising the display substrate according to claim 12.

29. A display device, comprising the display substrate according to claim 13.

30. A display device, comprising the display substrate according to claim 14.

31. A display device, comprising the display substrate according to claim 15.
